(19) United States
(12) Patent Application Publication
(10) Pub. No.: US 2004/0051768 A1
(43) Pub. Date: Mar. 18, 2004

(54) Preparing lithographic printing plates

(75) Inventors: Charles D. DeBoer, Palmyra, NY (US); Thomas P. Szumla, Lockport, NY (US); David A. Niemeyer, Rochester, NY (US)

Correspondence Address: Thomas H. Close, Patent Legal Staff, Eastman Kodak Company, 343 State Street, Rochester, NY, 14650-2201, US

(73) Assignee: Eastman Kodak Company

(21) Appl. No.: 10/242,171

(22) Filed: Sep. 12, 2002

(51) Int. Cl. B41J 3/407

(52) U.S. Cl. 347/106

(57) ABSTRACT

A method for preparing lithographic plates including preparing a lithographic printing plate by coating a substrate with a mixture including silica, alumina and a polymeric amine; overcoating the coating with a protective layer; using an inkjet printer with pigmented inks to print a digital image on the coated substrate; and drying the inkjet image.

### FIELD OF THE INVENTION

This invention relates to the preparation of lithographic printing plates.

### BACKGROUND OF THE INVENTION

Lithographic printing is based upon the immiscibility of oil and water, wherein the image area preferentially retains the oily material or ink. When a suitably prepared surface is moistened with water and ink is then applied, the background or non-image area retains the water and repels the ink while the image area accepts the ink and repels the water. The ink on the image area is then transferred to the surface of a material upon which the image is to be reproduced; such as paper, cloth and the like. Commonly the ink is transferred to an intermediate material called the blanket which in turn transfers the ink to the surface of the material upon which the image is to be reproduced.

A very widely used type of lithographic printing plate has a light-sensitive coating applied to an aluminum base. The coating may respond to light by having the portion which is exposed become soluble so that it is removed in the developing process. Such a plate is referred to as positive-working. Conversely, when that portion of the coating which is exposed becomes hardened, the plate is referred to as negative-working. In both instances the image area remaining is ink-receptive or oleophilic and the non-image area or background is water-receptive or hydrophilic. The differentiation between image and non-image areas is made in the exposure process where a film is applied to the plate with a vacuum to insure good contact. The plate is then exposed to a light source, a portion of which is composed of UV radiation. In the instance where a positive plate is used, the area on the film that corresponds to the image on the plate is opaque so that no light will strike the plate, whereas the area on the film that corresponds to the non-image area is clear and permits the transmission of light to the coating which then becomes more soluble and is removed. In the case of a negative plate the converse is true. The area on the film corresponding to the image area is clear while the non-image area is opaque. The coating under the clear area of film is hardened by the action of light while the area not struck by light is removed. The light-hardened surface of a negative plate is therefore oleophilic and will accept ink while the non-image area which has had the coating removed through the action of a developer is desensitized and is therefore hydrophilic.

One form of digital lithographic plate is known as “Direct write photothermal litho plates”. Kodak Polychrome Graphics sells such a plate under the name “Thermal Gold Plate”. However, these plates require wet processing in alkaline solutions. It would be desirable to have a direct write photothermal litho plate that did not require any processing.

U.S. Pat. No. 5,372,907 describes a direct write litho plate which is exposed to a laser beam, then heated to crosslink and thereby prevent the development of the exposed areas and to simultaneously render the unexposed areas more developable. The plate is then developed in conventional alkaline plate developer solution. The problem with this is that developer solutions and the equipment that contains them require maintenance, cleaning, and periodic developer replenishment, all of which are costly and cumbersome.

U.S. Pat. No. 4,034,183 describes a direct write litho plate without development whereby a laser absorbing hydrophilic top layer coated on a base is exposed to a laser beam to burn the absorber to convert it from an ink repelling to an ink receiving state. All of the examples and teachings require a high power laser, and the run lengths of the resulting litho plates are limited.

U.S. Pat. No. 3,832,948 describes both a printing plate with a hydrophilic layer that may be ablated by strong light from a hydrophobic base and also a printing plate with a hydrophobic layer that may be ablated from a hydrophilic base. However, no examples are given.

U.S. Pat. No. 3,964,389 describes a no process printing plate made by laser transfer of material from a carrier film (donor) to a lithographic surface. The problem of this method is that small particles of dust trapped between the two layers may cause image degradation. Also, two sheets to prepare is more expensive.

U.S. Pat. No. 4,054,094 describes a process for making a litho plate by using a laser beam to etch away a thin top coating of polysilicic acid on a polyester base, thereby rendering the exposed areas receptive to ink. No details of run length or print quality are giving, but it is expected that an uncrosslinked polymer such as polysilicic acid will wear off relatively rapidly and give a short run length of acceptable prints.

U.S. Pat. No. 4,081,572 describes a method for preparing a printing master on a substrate by coating the substrate with a hydrophilic polyamic acid and then imagewise converting the polyamic acid to melanophilic, polyimide with heat from a flash lamp or a laser. No details of run length, image quality or ink/water balance are given.

U.S. Pat. No. 4,731,317 describes a method for making a litho plate by coating a polymeric diazo resin on a grained anodized aluminum litho base, exposing the image areas with a yttrium aluminum garnet (YAG) laser, and then processing the plate with a graphic arts lacquer. The lacquering step is inconvenient and expensive.

Japanese Kokai No. 55/105560 describes a method of preparation of a litho plate by laser beam removal of a hydrophilic layer coated on a oliophilic base, in which a hydrophilic layer contains colloidal silica, colloidal alumina, a carboxylic acid, or a salt of a carboxylic acid. The only examples given use colloidal alumina alone, or zinc acetate alone, with no crosslinkers or addenda. No details are given for the ink/water balance or limiting run length.

WO 92/09934 describes and broadly claim any photosensitive composition containing a photoacid generator and a polymer with acid labile tetrahydropyranyl groups. This would include a hydrophobic/hydrophilic switching lithographic plate composition. However, such a polymeric switch is known to give weak discrimination between ink and water in the printing process.

EP 0 562 952 B1 describes a printing plate having a polymeric azide coated on a lithographic base and removal of the polymeric azide by exposure to a laser beam. No printing press examples are given.

U.S. Pat. No. 5,460,918 describes a thermal transfer process for preparing a litho plate from a donor with an oxazoline polymer to a silicate surface receiver. A two sheet system such as this is subject to image quality problems from dust and the expense of preparing two sheets.

EP 0 503,621 A1 discloses a direct lithographic plate making method which includes jetting a photocuring ink onto the plate substrate, and exposing the plate to UV radiation to harden the image area. An oil-based ink may then be adhered to the image area for printing onto a printing medium. However, there is no disclosure of the resolution of ink drops jetted onto the substrate, or the durability of the lithographic printing plate with respect to printing runlength.

Canadian Patent No. 2,107,980 discloses an aqueous ink composition which includes a first polymer containing a cyclic anhydride or derivative thereof and a second polymer that contains hydroxyl sites. The two polymers are thermally crosslinked in a baking step after imaging of a substrate. The resulting matrix is said to be resistant to an acidic fountain solution of an offset printing process. The Examples illustrate production of imaged plates said to be capable of lithographic runlengths of from 35,000 to 65,000 copies, while a non-crosslinked imaged plate exhibited a runlength of only 4,000 copies

U.S. Pat. No. 5,364,702 discloses an ink-jet recording layer supported on a substrate, with the ink receiving layer containing at least one of acetylene glycol, ethylene oxide addition product and acetylene glycol and acetylene alcohol, each of which have a triple bond in its molecule. The ink receiving layer may also contain an inorganic pigment such as silica, a water-soluble polymeric binder, and a cationic oligomer or polymer. No discussion of porosity is provided.

U.S. Pat. No. 5,820,932 discloses a process for the production of lithographic printing plates. Ink jet liquid droplets form an image upon the surface of a printing plate corresponding to digital information depicting the image as provided by a computer system which is in communication with the printer heads. The droplets from the printer head comprise resin forming reactants which polymerize on the plate surface, alone or in combination with reactant precoated on the plate, to form a printable hard resin image. The resin image so formed provides a lithographic printing plate useful for extended print runs.

All of the above listed methods for preparing lithographic printing plates by printing the image with an inkjet printer require the use of a special ink or fluid in the inkjet printer.

It would be desirable to have a way to prepare lithographic printing plates easily and inexpensively from a digital image file stored on a computer, utilizing a commercially available inkjet printer with commercially available inkjet inks.

### SUMMARY OF THE INVENTION

It is an object of this invention to provide a way of preparing a lithographic printing plate utilizing an inkjet printer.

It is another object of this invention to provide a way of preparing a lithographic printing plate cheaply and economically.

It is a further object of this invention to provide a way of preparing a lithographic printing plate producing high quality press impressions.

These objects are achieve in a method for preparing lithographic plates comprising the steps of:

(a) preparing a lithographic printing plate by coating a substrate with a mixture including silica, alumina and a polymeric amine;

(b) overcoating the coating with a protective layer;

(c) using an inkjet printer with pigmented inks to print a digital image on the coated substrate; and

(d) drying the inkjet image.

An advantage of this invention is that the lithographic printing plates can be prepared from digital sources with minimal cost and difficulty.

Another advantage of this invention is that the lithographic printing plates can be prepared utilizing commercially available inkjet printers with commercially available inkjet inks.

### BRIEF DESCRIPTION OF THE DRAWINGS

FIG. 1 shows a side view of the lithographic printing plate of this invention; and

FIG. 2 shows a digital inkjet image being applied to the lithographic printing plate as a series of droplets of inkjet pigmented ink impinging on and being absorbed by the lithographic printing plate.

### DETAILED DESCRIPTION OF THE PREFERRED EMBODIMENTS

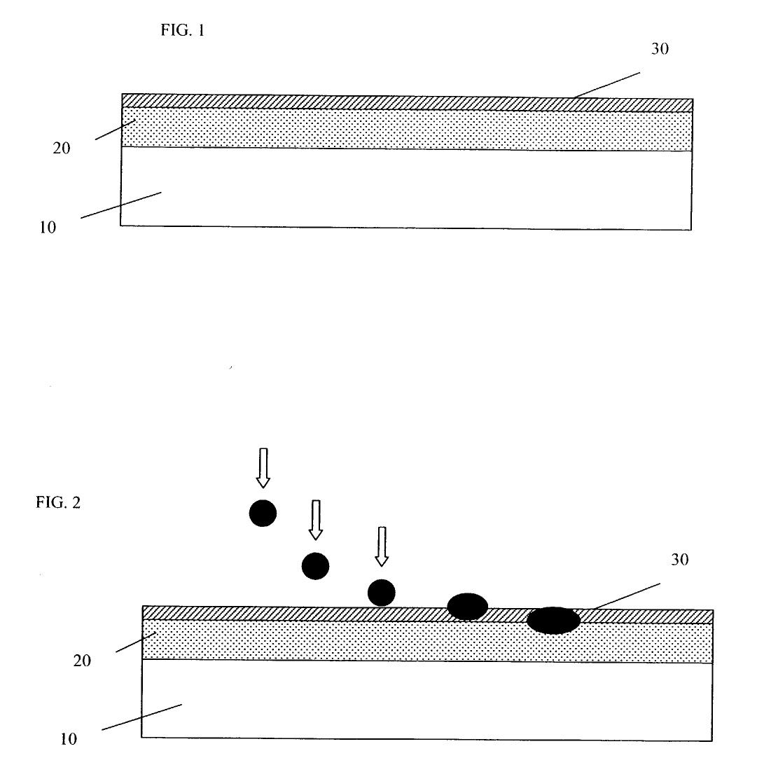

FIG. 1 shows a side view of a lithographic printing plate in accordance with the present invention. A substrate 10 formed a suitable material is shown with an adsorptive overcoat 20 including a mixture of silica, alumina, and a polymeric amine. This overcoat 20 can be formed by spin coating, extrusion hopper coating, roll coating, wire wound rod coating, or any of the common coating methods known to those skilled in the art. Overcoat 20 is in turn overcoated with a protective layer 30. The protective layer 30 can be formed in a similar fashion as overcoat 20 using well known coating methods. The purpose of protective layer 30 is to protect the overcoat 20 and especially can prevent accidental deposition of oleophilic materials such as fingerprints.

The substrate 10 can be mechanically or electrochemically grained aluminum. Graining aluminum to prepare a lithographic printing plate substrate is well known to those skilled in the art of lithography. The grained surface has an average roughness on the order of a few microns. The rough surface has an increased ability to carry water and thus repel lithographic ink in the offset printing process. In the present invention, the overcoat 20 carries water necessary to form lithographic prints. The function of the graining process in the present invention is to provide a physical anchor for the overcoat 20, and to promote adhesion between the substrate 10 and the overcoat 20. In addition, some of the roughness of the graining is conformably carried to be shown in the surface of the top layer of the lithographic printing plate. This roughness improves the ability of the lithographic printing plate to carry water in the offset printing process. Other materials such as polymeric supports can also be used as the substrate 10 Polyesters such as polyethyleneterphthalate are effective for providing the substrate 10.

The overcoat 20 includes a mixture of silica, alumina, and a polymeric amine, coated out of water. The mixture may also contain hardening agents such as formaldehyde, bis-vinylsulfone, gluteraldehyde, and similar materials that are known to crosslink polymeric amines by those skilled in the art. The mixture may also contain surfactants to improve spreading and uniformity of the coating. The mixture may also contain other materials to increase the hydrophilic character of the coating, such as quaternized polymeric amines. Other materials may be added to the mixture for cosmetic purposes, such as colorants of various kinds such as dyes or pigments.

The amount of silica in the coating mixture may vary from about 2 percent to about 15 percent, more preferably from about 5 percent to about 7 percent. The amount of alumina in the coating mixture may vary from about 1 percent to about 15 percent, more preferably from about 4 percent to about 6 percent. The amount of polymeric amine in the coating mixture may vary from about 0.1 percent to about 2 percent, more preferably from about 0.4 percent to about 0.7 percent. The kind of silica used in the coating mixture is preferably one that is compatible with a polymeric amine. It has been found that acidic colloidal silica, such as Ludox CL from the DuPont Company, Wilmington, Del., is compatible with polymeric amines. The polymeric amine may be a linear or branched polymer where the amine is part of the polymer backbone chain, such as polyethyleimine, or can be a polymer where the amine is an appendage from the polymer backbone, such as polyvinybenzylamine or polyallylamine. Most preferably, the amine is a primary or secondary amine. Least preferred are aromatic amines. The polymeric amine may be neutralized with an equivalent amount of mineral acid such as hydrochloric or sulfuric acid before being mixed with the colloidal silica. The alumina used in the coating mixture is preferably a fine particle alumina such as Oxide-C from DeGussa, Dusseldorf, Germany. A hardener, if used, is added to the mixture in an amount equal to about 1% to about 10% of the polymeric amine. Coating surfactants are used in amount equal to about 0.01% to about 1% of the total weight of the solution. The coating mixture can be spread over the substrate 10 by a number of coating methods well known to those skilled in the art, including wire wound rods, rollers, knives, bill blades and extrusion hoppers. The wet thickness of the coated layer may vary from about 1 micron to about 100 microns, more preferably from about 10 microns to 40 microns. The coating is air dried, with or without warming, to give the adsorptive overcoat 20.

The protective layer 30 has been described in commonly-assigned U.S. Pat. Nos. 6,050,193 and 6,044,762 hereby incorporated by reference. The protective layer has a composition that enables it to receive (or possibly absorb or dissolve) the inkjet ink. The inkjet ink exhibits a contact angle of at least 20 degrees, and preferably at least 30 degrees. Practically, the contact angle is generally less than 100 degrees. The minimum contact angle is necessary to reduce the spread of the applied fluid. Contact angle (static) can be readily measured using a commercially available Rame-Hart Contact Angle goniometer. The contact angle is measured after application of an inkjet ink droplet to a dried protective layer prepared out of a 5% (by weight) solution of the desired protective layer material that has been spun coated on a glass support at 2000 rpm.

The protective layer rapidly absorbs, or dissolves within, the inkjet ink fluid so that upon drying, the area to which the inkjet ink fluid is applied is discrete and the protective layer becomes firmly attached to the underlying hydrophilic support. In addition, the non-imaged areas of the protective layer must be sufficiently soluble in water or conventional fountain solutions so they can be removed after imaging. Thus, the non-imaged areas may be removed when ink and a fountain solution are applied or in a separate step prior to inking. Materials used for the protective layer 30 include gum arabic, algin, carrageenan, fucoidan, laminaran, corn hull gum, gelatin, gum ghatti, karaya gum, locust bean gum, pectin, a dextran, agar, guar gum, hydroxypropylcellulose, hydroxyethylcellulose, hydroxypropylmethylcellulose, carboxymethylcellulose, polyvinyl alcohol, a polyacrylamide, polyethylenimine or polyvinylpyrrolidone. In a preferred embodiment of the invention, the protective layer 30 is gum Arabic (acacia gum). The preferred thickness of the protective layer 30 is from about 0.5 microns to about 5 microns, and more preferably from about 1 micron to about 2 microns. The protective layer 30 can be coated from a water based solution, preferably with a wet coating thickness of from about 10 microns to about 40 microns. The protective layer 30 is then air dried, with or without heat, to produce a solid protective layer.

FIG. 2 shows the imaging process for the lithographic printing plate. Drops of inkjet pigmented ink are shown as black circles moving in the direction of the arrows. The ink drops are emitted from an inkjet print head (not shown). As shown in FIG. 2, as the drop encounters the lithographic printing plate the drops are adsorbed into the overcoat 20 and protective layer 30, and dried to form an image pixel that is attractive to lithographic printing ink. The unimaged or background area holds water or fountain solution on the printing press and repels lithographic printing ink. It has been discovered that all the pigment based inkjet inks that have been tried will form an image that will attract or accept lithographic printing ink on a press. In contrast, the commonly used dye based inkjet inks will not form an image that will attract or accept lithographic printing ink on a press. Pigment based inkjet inks are commonly made by grinding a pigment in water with a polymeric dispersing agent, as is well known to those skilled in the art. It has been found that a solution of a polymeric dispersing agent, without added pigment, will also function in this invention to form an image that will attract or accept lithographic printing ink on a press. It is believed that the polymeric dispersing agent is the active material in forming an image on the lithographic printing plate of the present invention, and that the pigment just goes along for the ride. Nonetheless, the pigment serves a valuable function in this invention, because it makes the image visible, so that the press operator can judge the quality and position of the image when mounting the lithographic printing plate on a press.

The following examples will illustrate the practice of the invention.

### EXAMPLES

### Example 1

A mixture was prepared in water, having the following composition:

6.138% colloidal silica

0.159% divinylsulfone

0.5845% polyetheneimine, neutralized with sulfuric acid

5.3% fumed alumina (Degussa Oxide-C)

0.02% surfactant Olin 10-G

The mixture was coated onto a 0.005 inch thick grained anodized aluminum support with a 25 micron Meyer Rod and allowed to dry. The lithographic printing plate was then placed in the paper feed tray of an Epson Stylus Color 980 Inkjet Printer equipped with Epson Black Pigment Ink. An image was printed onto the lithographic printing plate, which was then dried at 100 degrees for 10 minutes. The lithographic printing plate was then mounted on an ABDick press and 20,000 high quality impressions were made.

### Example 2

A lithographic printing plate was prepared as in Example 1 and placed in the paper feed tray of an Epson Stylus C80 printer equipped with Epson Stylus C80 inks. An image was printed onto the lithographic printing plate, which was then dried at 100 degrees for 10 minutes. The lithographic printing plate was then mounted on an ABDick press and 2,000 high quality impressions were made.

### Example 3

A mixture was prepared in water, having the following composition:

6.138% colloidal silica

0.02% formaldehyde

0.5845% polyetheneimine, neutralized with sulfuric acid

5.3% fumed alumina

0.02% surfactant Olin 10-G

The mixture was coated onto a 0.005 inch thick grained anodized aluminum support with a 25 micron Meyer Rod and allowed to dry. The lithographic printing plate was then placed in the paper feed tray of an Epson Stylus Color 980 Inkjet Printer equipped with Epson Black Pigment Ink. An image was printed onto the lithographic printing plate, which was then dried at 100 degrees for 10 minutes. The lithographic printing plate was then mounted on an ABDick press and 5,000 high quality impressions were made.

### Example 4

A mixture was prepared in water, having the following composition:

6% colloidal silica

0.02% formaldehyde

0.6% polyallylamine, neutralized with sulfuric acid

5% fumed alumina

0.02% surfactant Olin 10-G

The mixture was coated onto a 0.005 inch thick grained anodized aluminum support with a 25 micron Meyer Rod and allowed to dry. The lithographic printing plate was then placed in the paper feed tray of an Epson Stylus Color 980 Inkjet Printer equipped with Epson Black Pigment Ink. An image was printed onto the lithographic printing plate, which was then dried at 100 degrees for 10 minutes. The lithographic printing plate was then mounted on an ABDick press and 5,000 high quality impressions were made.

### Example 5

A mixture was prepared in water, having the following composition:

6% colloidal silica

0.02% formaldehyde

0.6% poly N,N-Dimethyl-3,5-dimethylene piperidinium chloride

5% fumed alumina

0.02% surfactant Olin 10-G

The mixture was coated onto a 0.005 inch thick grained anodized aluminum support with a 25 micron Meyer Rod and allowed to dry. The lithographic printing plate was then placed in the paper feed tray of an Epson Stylus Color 980 Inkjet Printer equipped with Epson Black Pigment Ink. An image was printed onto the lithographic printing plate, which was then dried at 100 degrees for 10 minutes. The lithographic printing plate was then mounted on an ABDick press and 5,000 high quality impressions were made.

### Example 6

A mixture was prepared in water, having the following composition:

6.138% colloidal silica

0.159% formaldehyde

0.5845% polyetheneimine, neutralized with sulfuric acid

0.5% poly(1-vinylpyrrolidone-co-2-dimethylaminoethylmethacrylate), quaternized with diethyl sulfate

5.3% fumed alumina (Degussa Oxide-C)

0.02% surfactant Olin 10-G

The mixture was coated onto a 0.005 inch thick grained anodized aluminum support with a 25 micron Meyer Rod and allowed to dry. The lithographic printing plate was then placed in the paper feed tray of an Epson Stylus Color 980 Inkjet Printer equipped with Epson Black Pigment Ink. An image was printed onto the lithographic printing plate, which was then dried at 100 degrees for 10 minutes. The lithographic printing plate was then mounted on an ABDick press and 1,000 high quality impressions were made.

Control 1

A lithographic printing plate was prepared as in Example 1. The lithographic printing plate was printed with an Epson 980 printer equipped with Epson 980 dye based inks. The lithographic printing plate was dried at 100 degrees for 10 minutes. The lithographic printing plate was then mounted on an ABDick press but no quality impressions could be made, just blank white impressions.

Control 2

The Epson C80 printer was used to print directly on the grained anodized aluminum plate substrate, without the silica overcoat described in the examples. The resulting image was so blurred that no attempt was made to put the lithographic printing plate on a printed press.

The invention has been described in detail, with particular reference to certain preferred embodiments thereof, but it should be understood that variations and modifications can be effected with the spirit and scope of the invention.

PARTS LIST

| | |
|---|---|
| 10 | substrate |
| 20 | adsorptive overcoat |
| 30 | protective layer |

What is claimed is:

1. A method for preparing lithographic plates comprising the steps of:
(a) preparing a lithographic printing plate by coating a substrate with a mixture including silica, alumina and a polymeric amine;
(b) overcoating the coating with a protective layer;
(c) using an inkjet printer with pigmented inks to print a digital image on the coated substrate; and
(d) drying the inkjet image.

2. The method of claim 1 wherein the protective layer includes a water soluble polymer having a contact angle of at least 20 degrees with pigmented water based inkjet inks.

3. The method of claim 1 wherein the substrate is grained aluminum or polyester.

4. The method of claim 3 wherein the polyester is polyethyleneterphthalate.
